(19) United States
(12) Patent Application Publication
(10) Pub. No.: US 2019/0320061 A1
(43) Pub. Date: Oct. 17, 2019

(54) PROXIMITY-BASED EVENT NETWORKING SYSTEM AND WEARABLE AUGMENTED REALITY CLOTHING

(71) Applicant: MAGNET SMART NETWORKING, INCORPORATED, Kensington, MD (US)

(72) Inventors: Ricardo Scott SALANDY-DEFOUR, Kensington, MD (US); Jacob MADDEN, Schenectady, NY (US)

(21) Appl. No.: 16/384,341

(22) Filed: Apr. 15, 2019

Related U.S. Application Data
(60) Provisional application No. 62/657,176, filed on Apr. 13, 2018.

(51) Int. Cl. H04M 1/725; H04W 4/02; H04W 4/33; G06Q 50/00

(52) U.S. Cl. CPC H04M 1/72572; G06Q 50/01; H04W 4/33; H04W 4/025

(57) ABSTRACT

According to an embodiment a method for proximity-based networking is described. A position of a user's client device, e.g., a cell phone, is estimated. Then, other users in a same region as the user's client device are identified based on the estimated position. Locations of those identified other users having one or more interests in common with the user can be displayed on a map on the user's client device.

### RELATED APPLICATION

The present application is related to, and claims priority from U.S. Provisional Patent Application No. 62/657,176, entitled “PROXIMITY BASED EVENT NETWORKING SYSTEM AND WEARABLE AUGMENTED REALITY CLOTHING”, to Ricardo Scott Salandy-Defour and Jacob Madden filed Apr. 13, 2018, the entire disclosure of which is incorporated here by reference.

### TECHNICAL FIELD

Embodiments described herein relate in general to location-based systems and, more particularly, to a proximity-based event networking systems and wearable augmented reality clothing associated therewith.

### BACKGROUND

Accurately determining the geographic position of a mobile user within a wireless communication network is an ongoing challenge in wireless telecommunications development. Government mandates, such as the E-911 positioning requirements in North America, and commercial Location Based Services (LBS) demand rapid and accurate position determination for user equipment (UE). Determining a location of user equipment is frequently referred to as “positioning” in the radiocommunication art. The accurate positioning of a UE becomes more challenging when considering indoor scenarios where, for example, Assisted GPS signals are less detectable.

Several position determination methods, of varying accuracy and complexity, are known in the art. These include cell ID positioning, Round Trip Timing (RTT) positioning, Observed Time Difference of Arrival (OTDOA) positioning, Assisted Global Positioning System (A-GPS) positioning, and fingerprinting positioning. Some of these positioning techniques will now be described in more detail.

For example, Assisted GPS (A-GPS) positioning is an enhancement of the global positioning system (GPS), an exemplary architecture of which is illustrated in FIG. 1. Local GPS reference receiver networks/Global reference receiver networks collect assistance data from GPS satellites, such as ephemeris data. The assistance data, when transmitted to GPS receivers in UEs connected to the cellular communication system, enhance the performance of the UE GPS receivers. Typically, A-GPS accuracy can become as good as plus or minus ten meters without differential operation. However, this accuracy becomes worse in dense urban areas and indoors, where the sensitivity of the GPS receivers in UEs is most often not high enough for detection of the relatively weak signals which are transmitted from the GPS satellites.

Regardless of which technology is used to locate a user's mobile device, the resulting location information is available for commercial and government usage. For example, various location tracking applications (“apps”) are currently available to source a device's location to other apps, e.g., location tracking apps such as Google Latitude, Find My Friends, Nearby and Pathshare. Such location tracking apps return, e.g., the longitude, latitude and, optionally, a confidence indicator (indicating a likelihood that a device is actually within a certain area around the identified coordinates) to other apps which then use that location information in various ways. For example, local mobile search apps can use this location data to enable users to search for businesses, events, and products which are near to their current location.

Local mobile search apps like Around Me provide users with valuable information about their local product and service providers, which takes advantage of location data which is available from today's networks to inform a user of businesses and services that are available in his or her current location area. However such apps are also relatively static in nature, e.g., providing static information about a business like business address and phone number, and they also typically provide little more information than that which is available from web based services like Google Maps. Additionally, most are centered around matchmaking between businesses and customers, rather than between individuals. Moreover, most of these location-based services, and positioning techniques, are optimized for outside location-based services and detection rather than indoor location based services and detection.

As an example, GPS (described above) is often used for outdoor position tracking. Atmospheric factors and other error sources such as multipath propagation affect the accuracy of GPS receivers but a majority of the time the accuracy is within 3 to 15 meters. For indoor purposes, this is already insufficient since it cannot help to identify a specific room or portion of a room where an end-user is located. When indoors, signals from GPS satellites are attenuated and scattered by roofs, walls and other objects, leading to erroneous readings and much larger instability in the accuracy of position estimates. Mobile device operating system (OS) developers such as Apple and Google utilize Assisted GPS (A-GPS) with cell tower triangulation and have incorporated filtering and sensor fusion techniques to integrate latent Wi-Fi signals, but the results for indoor position estimation performance and stability are much worse than when outdoors.

There are other approaches for improving indoor position tracking, such as populating the indoor space with Bluetooth Low Energy (BLE) beacons that transmit a continuous stream of packets that are picked up by a BLE sensor on the mobile device. Google developed a beacon packet format called Eddystone that has an alternative developed by Apple called iBeacon. While beacon-augmented spaces allow for improvements to indoor position tracking, with Estimote claiming an accuracy range of 1 to 4 meters with distance measurements to a specific beacon having errors 20-30% of the actual distance, in practice the accuracy can exceed 4 meters and fluctuates such that the user's position does not remain stable and sometimes drifts far away from the actual position. Position accuracy depends heavily on beacon placement and coverage and in general the room configuration. Certain rooms with a large open wall, rooms with glass walls, small rooms less than 4 meters by 4 meters, etc. present additional challenges that limit the accuracy of beacon-based approaches. When placing beacons manually, it is difficult to measure placement with accuracy and this introduces a source of error in the map and position estimation.

Recently, the deployment of on-device augmented reality toolkits has added a further capability to many mobile devices already owned by end-users. For example, Apple released ARKit and Google released ARCore. Both of these technologies utilize the mobile device sensors combined with the rear-facing camera(s), using sensor fusion techniques to perform visual inertial odometry (VIO), dead reckoning estimation and simple plane detection. These are not full visual SLAM (simultaneous localization and mapping) systems that are used in more expensive but less widely available augmented reality and virtual reality headsets, but are on the path towards this end. The toolkits allow for a further estimation of real-world metric movements (x,y,z position deltas) along with pose estimation (roll, pitch, yaw) that can be incorporated into an indoor position tracking stack.

However, alone the augmented reality technologies do not provide accurate world origin estimation and have limited capability for relocalization after losing track of a scene. Environmental visual features are used by the VIO system and in rooms with a lack of static visual features the system performs poorly. With bare walls, when people or objects are moving around or when the lighting changes significantly, the system is unable to track position effectively. The lack of two cameras on many devices also presents a challenge when trying to recreate a 3-dimensional scene. Variations in the camera lens from the factory without calibration also add a source of error that some newer devices are correcting. The heading estimation is also susceptible to large distortions, drifts and inaccuracies due to the usage of the mobile device's magnetometer. The magnetometer gives the impression that it is capable of determining true north, but in practice this is not true, especially indoors, due to environmental factors. The heading estimation is very important for correlating measurements to the real world and a drifting heading undermines many portions of the position estimation system with or without visual camera data. In addition, errors in the inertial system accumulate over time, requiring a correction. Dead reckoning IMU correction is helpful but challenging without additional sensor capabilities. ARCore has an added challenge due to the lack of Android device standardization and large variations in capability between devices on the market. ARCore itself is only supported by a small set of new devices available to end-users.

Another approach to indoor position tracking is to gather the magnitude and the direction of Earth's magnetic field using a magnetometer and gather latent Wi-Fi, cellular and Bluetooth signals using an RF receiver in a process known as location fingerprinting. When a complete location fingerprint has been created it can be used to determine the location of a mobile device in the space. IndoorAtlas is a leader in utilizing this technology. Embodiments described herein utilize IndoorAtlas to provide position estimates that incorporate magnetic field data and observations over a sequence of measurements. The accuracy depends on the location's magnetic field and how comprehensive the fingerprinting process was completed, which is a manual and labor-intensive process that includes calibrating a mobile device and covering the floor space in entirety through multiple walking paths. The accuracy is normally within 2 to 3 meters of the actual position. IndoorAtlas becomes less accurate when in open areas without enough steel structures.

Accordingly, it would be desirable to provide systems and methods for indoor positioning that are more accurate than existing systems and methods, and which can then be used to develop social interaction functions, such as networking at events based on proximity.

### SUMMARY

According to an embodiment, a proximity-based networking system includes a memory system for storing positioning data indicating estimated positions of a plurality of client devices within a building, wherein the positions are calculated as a function of: Estimated Position=A(GPS based location estimate))+B(Bluetooth beacon-based location estimate)+C(geomagnetic-based location estimate)+D(vision-based location estimates) where A, B, C and D are weighting values; wherein said memory system also stores one or more interests associated with each of the plurality of client devices; and one or more processors configured to identify two of the plurality of client devices as being a match when the two client devices are within a predetermined distance of one another based upon their stored positions and when the two client devices have at least one same or similar interest associated therewith.

According to an embodiment, a proximity-based networking system includes a matching server configured to receive information associated with estimated positions of a plurality of client user devices and further configured to receive information associated with users' interests in attending a networking event; and wherein a client user's device is configured to receive and to display information from the matching server associated with other users attending the networking event who have similar interests.

According to an embodiment, a method for proximity-based networking including estimating a position of a user's client device; identifying other users in a same region as the user's client device based on the estimated position; and displaying, on a map on the user's client device, locations of those identified other users having one or more interests in common with the user.

According to an embodiment, a proximity-based networking system includes a plurality of wearables each associated with different users at a networking event; and a matching server configured to receive information from a first user associated with one of the other users' associated wearable device and further configured to receive information associated with users' interests in attending the networking event; and wherein the matching server is configured to receive and to display information from associated with the one of the other users.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 depicts an exemplary positioning system;

FIG. 2 shows accuracy/confidence values returned by an Estimote positioning framework;

FIG. 3 illustrates a proximity-based matching network according to an embodiment;

FIGS. 4(a)-4(i) show user interface screens for a user app in a proximity-based matching network according to various embodiments;

FIG. 5 is a flowchart illustrating a method for proximity-based matching according to an embodiment;

FIG. 6 is an example of personality information which can be used in proximity-based matching according to an embodiment;

FIG. 7 is a computer system;

FIGS. 8(a)-8(d) depict various embodiments of wearables;

FIG. 9 shows various electronic hardware elements associated with the wearable embodiments; and

FIG. 10 is a flowchart illustrating a method according to an embodiment.

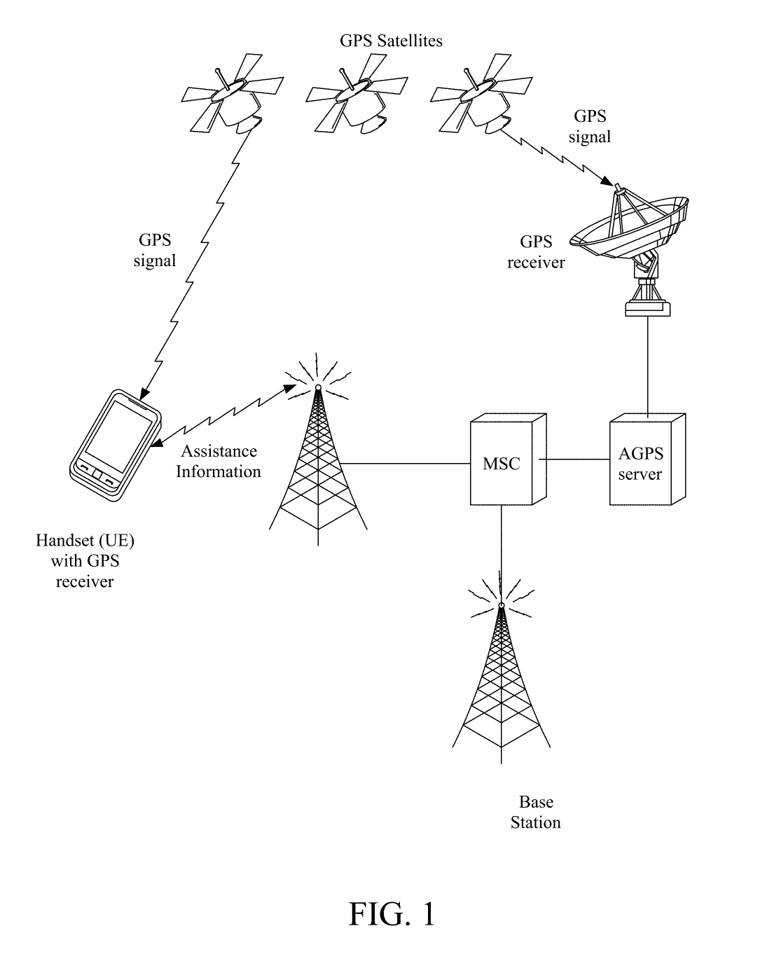

### DETAILED DESCRIPTION

The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of networks including positioning systems. However, the embodiments to be discussed next are not limited to these configurations, but may be extended to other arrangements as discussed later.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

As described above, end-user mobile devices contain various sensors that help to localize the device to a specific position in the real world. As devices evolve, additional sensors frequently get added to these mobile devices, which sensors also can be used to improve localization capabilities. Embodiments described herein utilize sensor fusion techniques which combine a number of different positioning techniques and sensor data to calculate the mobile device position. Then, the calculated mobile device position is used to, among other things, (a) detect the proximity of the end-user mobile device to other end-user mobile devices in the vicinity and (b) detect the proximity of the end-user mobile device to smart active and passive devices added to existing environments. Proximity-based user experiences are activated when appropriate. These proximity-based user experiences include, for example, proximity-triggered notifications, indoor navigation assistance/guidance, user-customized advertising and criteria-based user-to-user priority matching in 2D and augmented reality.

Accordingly, embodiments described below will first focus on sensor fusion techniques which enable accurate indoor positioning, and then matchmaking (networking) techniques which operate using the detected mobile device positions in combination with other data will be described. Subsequently, wearable augmented reality clothing that can interact with such proximity-based networking systems will be discussed in accordance with further embodiments.

### Positioning

As mentioned above, there exist a number of techniques for determining the position of a mobile device. Rather than select a single authoritative source for location estimation, embodiments described herein utilize information (sensor output) fusion to combine position estimates to improve indoor localization performance. These techniques enable visualizing the real-world position estimations of the various localization approaches for experimentation and comparison. Thus embodiments provide for an algorithm for updating the best known position estimates using a probabilistic combination of the various estimates.

According to an embodiment, the location information fusion algorithm uses as input the available location estimates. This can include, for example, native mobile device filtered GPS location estimates (e.g., CoreLocation on iOS), Bluetooth beacon-based location estimates (e.g., from Estimote), geomagnetic-based location estimates (e.g., from IndoorAtlas), and vision-based location estimates from a native mobile device augmented reality toolkit (e.g., ARKit on iOS). This location information fusion algorithm can be expressed as:

Estimated Position=A(GPS based location estimate))+B(Bluetooth beacon-based location estimate)+C(geomagnetic-based location estimate)+D(vision-based location estimates) (1)

where A, B, C and D are weighting values (whose values are described below)

The information fusion algorithm according to some embodiments operates under the following guiding principles. When several measurements are close in time, each measurement should be weighted according to the corresponding noise estimate with more noise leading to a lower weight. More recent measurements are assigned a higher weight versus older measurements. After exceeding a certain age, measurements are no longer included in position estimation. Since measurement inputs are already filtered sensor fusion measurements, only the latest measurement available for a particular input type is used in position estimation versus averaging or filtering from the latest several position measurements. Position measurements that exceed an estimated error threshold are not used to update the estimated position.

The information fusion algorithm seeks to combine different input sources in a weighted fashion such that those with the least error and most timeliness are prioritized. According to various embodiments, there can be a number of different methods to calculate input measurement weights and combine the measurements but the following describes one method of determining the updated position and error estimates according to an embodiment.

First, the measurements are preprocessed as discussed previously and then pruned to only include the latest inputs that satisfy age and error thresholds. Then the weights A, B, C and D are calculated for each input measurement. The first weight contribution is the inverse proportion of the error estimates that the input measurement covers and can be expressed as:

$${w}_{1} = 1 - \frac{{error}_{m}}{\sum error} \qquad ( 2 )$$

The second weight contribution is the inverse proportion of the measurement age and can be expressed as:

$${w}_{2} = 1 - \frac{{age}_{m}}{\sum age} \qquad ( 3 )$$

The combined weight for the input is then:

$${w}_{m} = \frac{{w}_{1} + {w}_{2}}{2} \qquad ( 4 )$$

The updated position estimate is then:

$$( \begin{matrix}{latitude}_{new} \\ {longitude}_{new}\end{matrix} ) = {\sum }_{all measurements m} {w}_{m} * ( \begin{matrix}{latitude}_{new} \\ {longitude}_{new}\end{matrix} ) \qquad ( 5 )$$

The updated error estimate is then:

error_{new}=Σ_{all measurements m}wₘ*errorₘ (6)

According to some embodiments, device or input measurement velocity and acceleration are not utilized when updating the position estimate but according to other embodiments such velocity and acceleration information may also be used to improve position estimation accuracy, as well as information associated with the distance and orientation of the device between previous position estimates

Position measurement updates according to some embodiments are provided at varying rates and include a timestamp, error estimate and position estimate calculated using equation (1). The timestamp is used to determine the age of the measurement, with older measurements being less helpful for estimating current position as discussed above with respect to calculating the weights. The estimated error is used to model the accuracy of the latest reading. The form of the estimated error is uncertainty in position in meters. Some inputs (e.g., Estimote) provide error measurements in discrete categories instead of as a continuous set of values. For such inputs, the discrete value is used when updating the overall estimated position. Since the error estimates are provided from the input itself and may not factor in system problems, the information fusion algorithm also calculates an adjusted error estimate that is actually used. The function takes in the error estimate and the input type and calculates an adjusted error estimate, that is normally the same error estimate but when necessary is a corrected version.

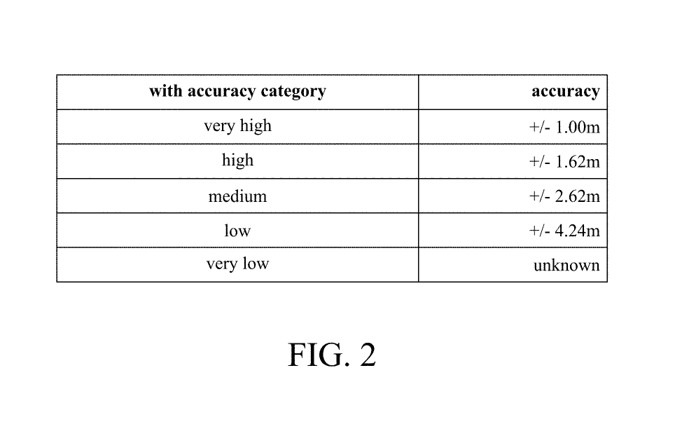

For example, as shown in the table of FIG. 2, the Estimote framework returns position updates which are received with an accuracy value that represents a discrete category of accuracy with each category representing the estimated error radius in meters for the estimated position measurement. Similarly, the IndoorAtlas position updates are received with a continuous accuracy that contains the estimated radius of error in position in meters. The native mobile device location services (e.g., CoreLocation) also offer a continuous accuracy estimate that contains the estimated radius of horizontal and vertical position measurement error in meter.

The position measurement is expected in geographic coordinates (latitude and longitude). For some inputs (e.g., Estimote), the position measurement is not in the form of geographical coordinates and a transformation is needed to change the measurement from the input coordinate frame to the desired information fusion output coordinate frame (geographical coordinates). For all inputs, the information fusion algorithm performs a translation and rotation step to account for any potential fixed offsets for a particular input type.

As those skilled in the art will appreciate, the position estimate updates from the various systems which provide the inputs to equation (1) are received by the proximity-based networking system at various times. As the new position estimates arrive, an overall position estimate for a particular user/user device is updated using a probabilistic combination of the four position updates, factoring in their individual accuracy confidence estimates and available sensor data as noted above. When a particular position estimation method is unavailable or performing poorly, the other methods will be used more heavily, thus allowing the determination of the best position estimate over time given the available information.

Various other features and aspects associated with positioning are described below, with respect to embodiments associated with system implementation. The discussion now turns to the usage of the positioning estimates of users/user devices in proximity-based event networking systems according to embodiments, i.e., their usage in matching functionality.

### Matching

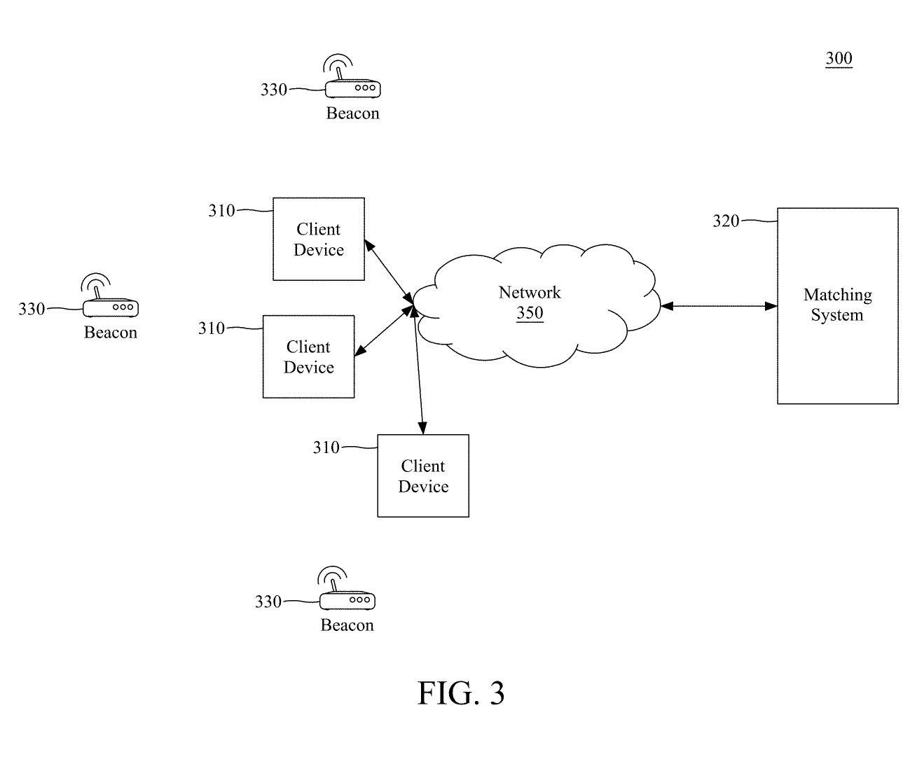

Using the afore-described sensor fusion positioning algorithm according to these embodiments are system, method and/or computer program product embodiments, and/or combinations and sub-combinations thereof, for configuring mobile devices and beacons to assist users in locating and meeting other users based on their proximity to one another, a system example being illustrated in FIG. 3 and described below. Embodiments provide a mobile device application that may match users who, for example, fit professional and/or psychosocial profiles as desirable social and/or professional contacts, where the users may find themselves in physical proximity. Embodiments may make use of a server in communication with physical beacons to determine the location or relative physical proximity of the users to each other in an in-person business or social networking event, and aid the users in locating each other.

FIG. 3 illustrates a user-to-user matching environment 300, according to an embodiment. In particular embodiments, a plurality of client devices 310 connect to a user-to-user matching system 320 through a network 350. The network may be any communications network suitable for transmitting data between computing devices, such as, by way of example, a Local Area Network (LAN), a Wide Area Network (WAN), Metropolitan Area Network (MAN), Personal Area Network (PAN), the Internet, wireless networks, satellite networks, overlay networks, etc., or any combination thereof. A client device 310 may be any computing device suitable for interacting with a user-to-user matching system, such as, by way of example, a personal computer, mobile computer, laptop computer, mobile phone, smartphone, personal digital assistant, tablet computer, an augmented reality (AR) device, a virtual reality (VR) device, a mixed reality (MR) device, etc. Matching system 320 may be any computing device or combination of devices suitable to provide user-to-user matching services, such as, by way of example, server computers, database systems, storage area networks, web servers, application servers, etc., or any combination thereof.

According to an embodiment, the positioning information fusion algorithm described above can be computed on the client device 310 in FIG. 3. The position measurements from all input types are also sent to the server (matching system 320) for storage in a database which is part of matching system 320, along with the updated overall estimated position and error. Alternatively, positioning data can be stored on the client data 310 after it is computed and accessed by the server when needed, e.g., using a blockchain implementation.

Matching system 320 may provide any suitable graphical user interface for client device 310, such as, by way of example, an application, web browser, web application, mobile application, etc. In particular embodiments, matching server 320 may provide an event attendee interface or an event organizer interface. For example, an attendee may download and install a mobile application to a smartphone that provides access to the services of matching system 320. In an example, the attendee application may allow the user to join the event (e.g., “Join the Software Developers Networking Event at the Hilton Hotel in Alexandria, Va. on August 23rd”) and specify an intent (e.g., “Meeting Python back-end developers”). In particular embodiments, the application may provide a user with a listing of events nearby or may allow the user to search for events that are registered in the application. In particular embodiments, the application may provide a list of intents for the user (e.g., “meeting developers,” “meeting marketing specialists,” “meeting business developers,” etc.). In particular embodiments, the application allows a user to enter a natural language entry describing their intent (e.g., “I am looking for an expert in IP Law that provides services for startup tech companies.”). In particular embodiments, one or more adaptive algorithms (e.g., algorithms powered by artificial intelligence, machine learning, AI resources such as IBM Watson, rules-based algorithms, etc.) are employed to automatically determine intents for users and/or match users. For example, an AI system may try to determine a user's intent based on his/her profile information. In particular embodiments, any of a number or all of the aforementioned criteria for matching users are used in any combination. In some embodiments herein, this application is referred to as a “persona app.”

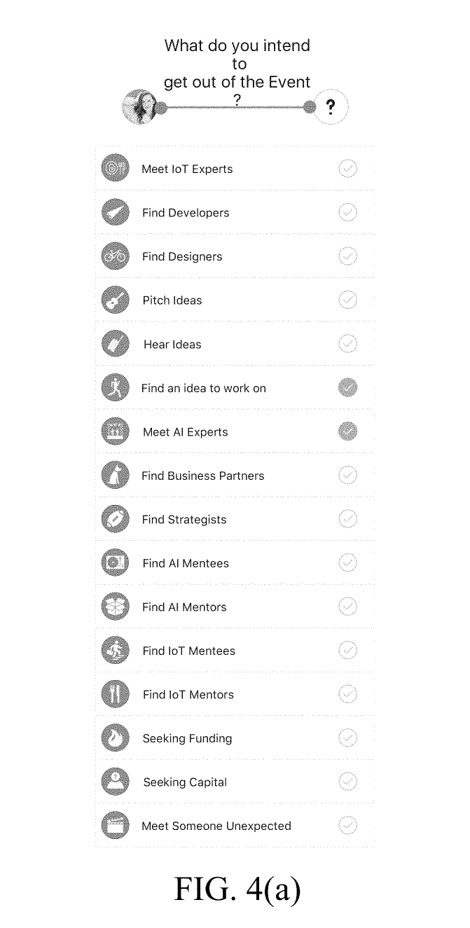

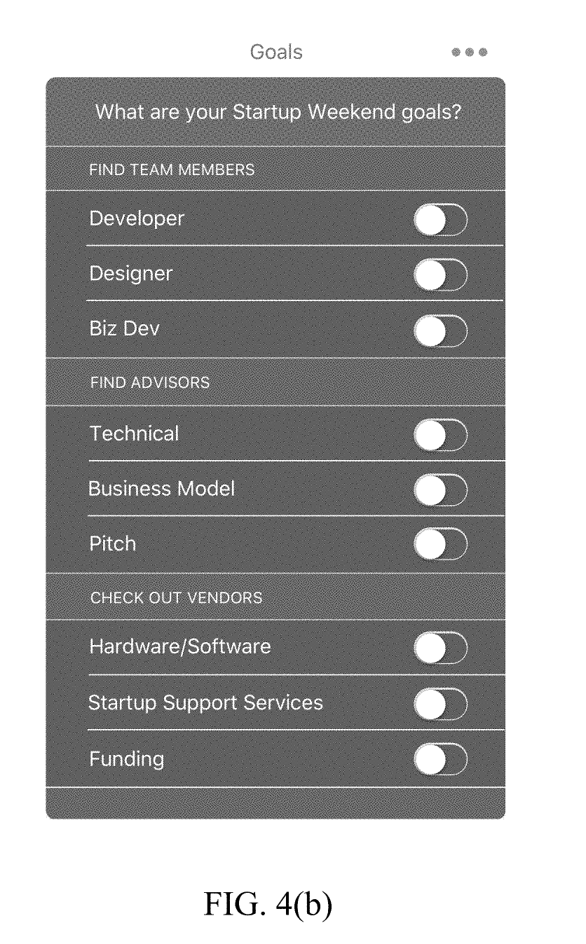

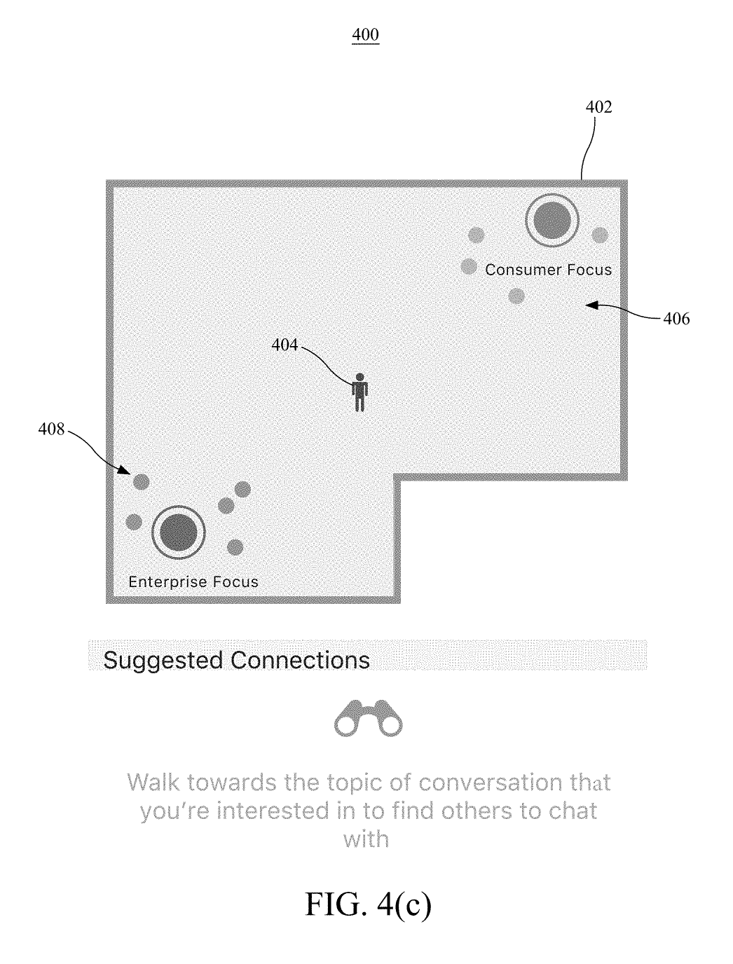

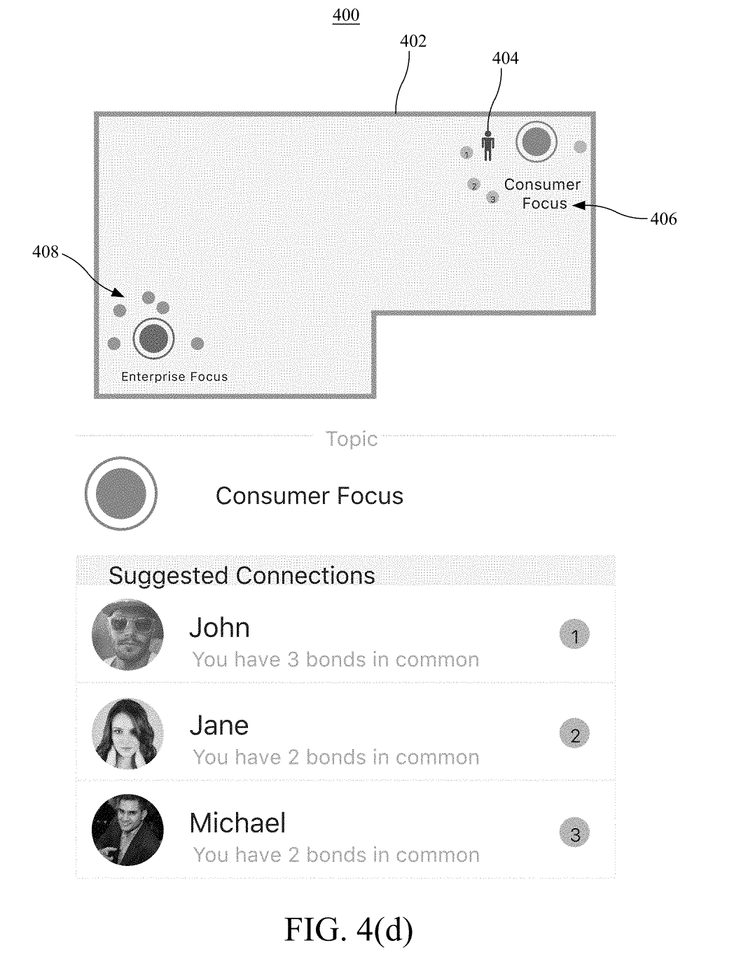

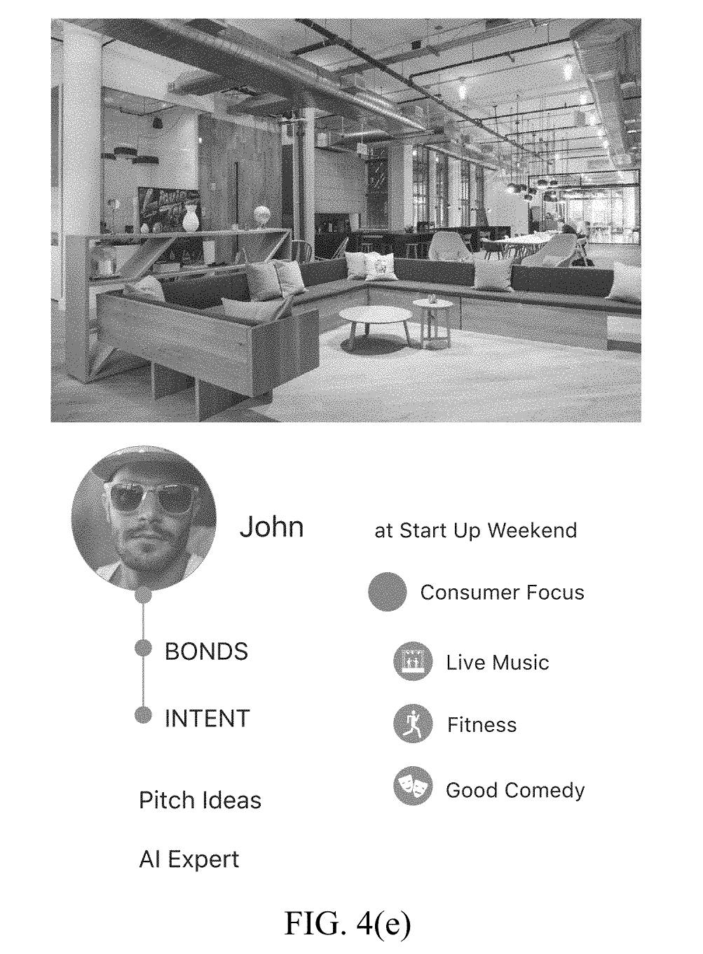

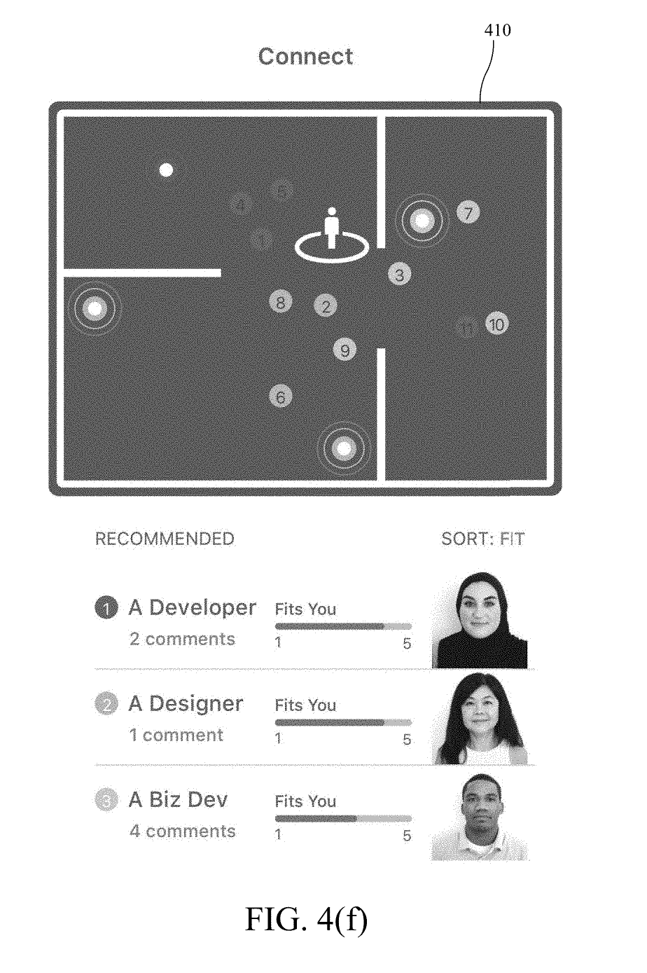

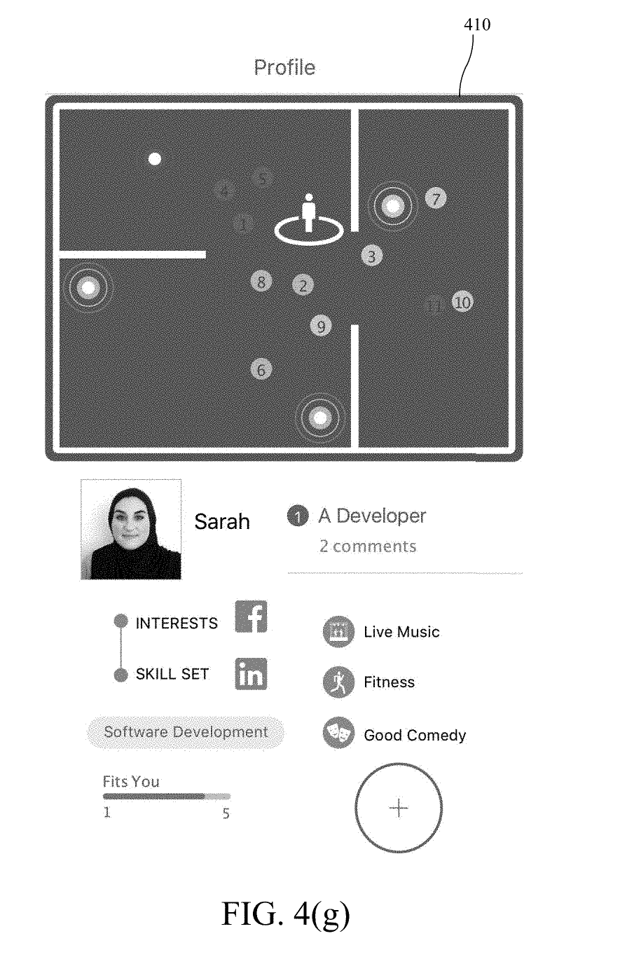

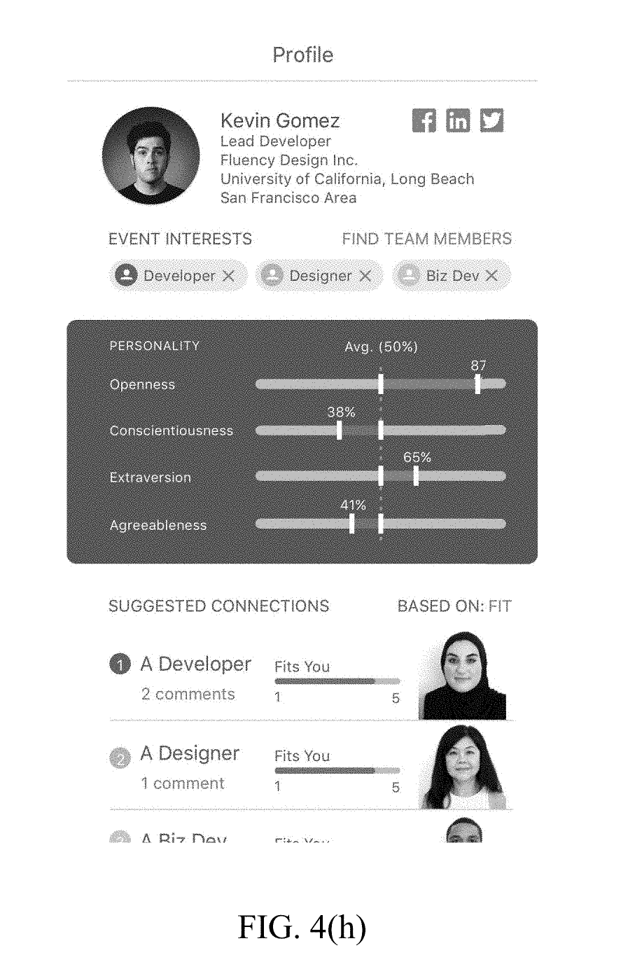

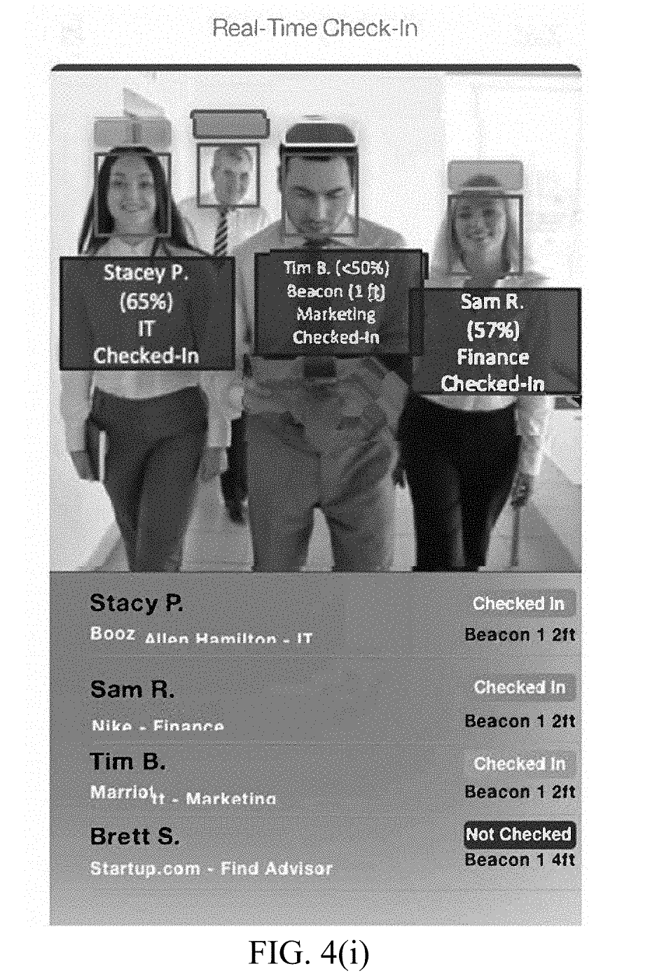

Examples of graphical user interface screens for such an application on a client device are shown in FIGS. 4(a)-4(i), which will be understood by those skilled in the art to be purely illustrative in nature. When embodiments described herein are used as an event organizer interface, an organizer may download and install an application into a smartphone, or access a website that allows the organizer to create and configure an event. The organizer may specify details for the event, such as, name, location, type, etc. In particular embodiments, the organizer may send invitations to potential attendees, or may indicate the event is public. The user can select, as illustrated in FIGS. 4(a) and 4(b) his or her intentions or goals for the event, which can be used by the matching system 320 to generate matches between event attendees. Such potential matches or connections can also be displayed on the user's client device as shown in FIGS. 4(c)-(h).

Starting with FIG. 4(c), a user interface screen 400 can include a map or outline 402 of the event location. The map or outline can include an indicator 404 of the user's current position, determined using any of the foregoing positioning techniques, as well as an indication of groups 406 and 408 of other people and their focus for the event. This provides an indication of which group the user 404 might gravitate to in order to participate in conversations that are relevant for his or her objectives at the event. If the user 404, for example, is interested in the group 406 that has a consumer focus, she or he could move over to that group and acquire more information about the individuals in that group, which information can be automatically displayed on the interface (see, e.g., FIG. 4(d) in response to either the user's proximity to the group or an interaction with the user interface screen 400. This part of the user interface 400 can have any number of detailed layers, e.g., a screen shown in FIG. 4(e) which provides more information about one of the specific individuals in group 406.

FIG. 4(f) provides another example of a user interface screen 410 which can be displayed on client device 310. In this example, a larger group of people is located in the same area as user 404, and their information is sorted based on a “fit” metric calculated based on their interests as well as the interests of user 404. By selecting one of the individuals, more information about that person's interest can be identified and displayed, e.g., as shown in FIG. 4(g). The user 404's own interests and personality traits can be set in a Profile user interface screen as shown in FIG. 4(h). The system can also facilitate real-time event check in using device proximity and/or facial recognition as shown in FIG. 4(i).

Environment 300 may further include a plurality of beacons 330 configured to determine an absolute or relative location of one or more client devices 310 in physical proximity. In particular embodiments, physical proximity may refer to an enclosed or delimited area, such as, for example, a room, a conference room, a convention center, a street block, a series of street blocks, etc. In particular embodiments, the plurality of beacons and triangulation system may be used by matching system 320 to identify the position of client devices 310 with a margin of error of a few inches or feet.

According to some embodiments, the beacons 330 can be involved in assisting with obtaining the position estimate of the user/user device in the sense that beacon signals are received by the client device 310 and converted to position estimates. With Estimote as an example, the beacon signal measurements are sent to Estimote Cloud which transforms the signals into a position estimate and sends that estimate back to the client device 310. This updated position measurement is then used in the information fusion algorithm described above to update the estimate for the overall device position and error.

Beacons 330 are placed at static and known positions within an enclosed or delimited area 300. In some embodiments, the beacons 330 are used for client device proximity detection instead of, or in addition to, client device position estimation. For the purposes of client device proximity detection, the client device 310 is estimating how far away each beacon 330 is from the currently estimated position of the client device 310. In these proximity detection cases, the client device 310 is scanning the enclosed or delimited area 300 at an interval, searching for signals from beacons 330 on a known list of beacons. The list of beacons 330 is provided to the client device 310 from the matching system 320 through the internal server API on application startup and at predetermined location junction points in the world (zone entry events).

In certain application contexts, the proximity detection of a beacon 330 being within a threshold distance from a particular client device 310 triggers a user experience customized to that specific location. The proximal distances between beacon(s) 330 and client devices 310 are also sent to the server 320 for analytic purposes. The proximity use case is independent of the position estimation discussed above.

However, for any displays of planar position on a map or in augmented reality, the source of the position estimation is from the information fusion algorithm described above which does incorporate beacon data when updating the estimated positions and this directly relates to the position estimate update process. In these embodiments, the placement of the beacons is done strategically and systematically around an enclosed or delimited area 300 with beacons 330 being placed at equal height and covering the circumference of the area. The distance between beacons 330 and overall distribution throughout a space 300 varies depending on the accuracy needs and budget of the particular customer. When a beacon 330 has been placed for indoor location purposes in an enclosed or delimited area 300, it may still be used for proximity purposes and applications as well. The two functions (positioning and proximity detection) are not mutually exclusive since the beacon 330 is transmitting the same data in both cases and the client device 310 may convert the received signals in parallel for each application purpose.

Although not explicitly shown in FIG. 3, beacons 330 may or may not be connected to matching system 320, either through network 350 or otherwise. In particular embodiments, the locations of the client devices 310 may be determined with relation to one or more static points (e.g., beacons 330), or may be determined relatively between particular client devices 310. In particular embodiments, beacons 330 may be configured to broadcast one or more wireless signals. The client application may configure client device 310 to receive various signals from multiple beacons 330 and record a strength of the signals. The signals may comprise any wireless signal, such as, for example, WiFi, Bluetooth, infrared, other electromagnetic signals, etc. The measured strength of the signals may then be used to determine a location of the client device 310 using triangulation techniques. In particular embodiments, the triangulation computations may be performed at one or more client devices 310, at the matching system 320, or a combination of both. For example, a client device 310 may transmit the measured signal strengths to matching system 320, which in turn determines a location of client device 310. In another example, matching system 320 may send information to client device 310 related to the beacon locations, client device 310 may perform the triangulation computations using this information and transmit the determined location to matching system 320. In particular embodiments, matching system 320 may generate a map of the approximate location of client devices 310 within a networking event venue using client device 310 data and beacon configuration data.

In particular embodiments, beacons 330 may comprise, in addition to or instead of wireless transmitters/receivers, one or more devices configured to capture input for computer vision analysis. In particular embodiments, beacons 330 may comprise one or more cameras, video cameras, etc., configured to capture images of the event and identify attendees and/or their locations using computer vision algorithms (e.g., facial recognition algorithms). For example, beacons 330 may capture still images or a video stream, and transmit information to matching system 320 for facial recognition analysis.

Similarly, matching system 320 may then use the facial recognition analysis (either exclusively or in combination with wireless triangulation as explained above), to determine the location of one or more attendees at the event. Matching system 320 may further use computer vision data to generate a real-time (or near real-time) map of the attendees at the event, and any additional services as illustrated by the examples described above with respect to wireless signal beacons.

In particular embodiments, matching system 320 provides event organizers instructions to configure the beacons 330 in an event meeting place to enable matching system 320 to accurately determine the location of client devices 310 within the venue. In particular embodiments, the event organizer application interface may display instructions for event organizers on the placement of beacons in a room. In particular embodiments, the event organizer interface may enable a user to enter information about the room (e.g., size, dimensions, etc.) and/or placement of beacons. In particular embodiments, the event organizer interface may provide the user with instructions to perform a calibration of the beacons to increase the accuracy of the system.

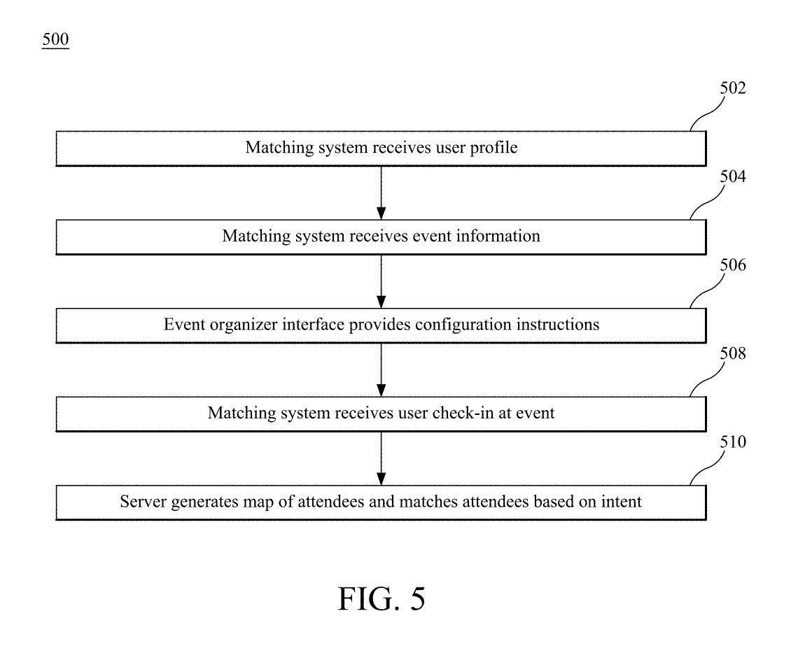

FIG. 5 is a flowchart for a method 500 for matching users based on social and/or professional characteristics and intents, where the users may find themselves in physical proximity. At step 502, matching system 320 receives a profile from a client device 310 including personal, professional, and/or psychosocial information by means of the attendee interface. In particular embodiments, the application may allow a user to import or share pre-existing information from other social media and/or professional networking profiles, e.g., Facebook, LinkedIn, Twitter, Instagram, Snapchat, etc. In particular embodiments, an attendee interface may provide for the user to input an intent for a particular event, a general intent for all events, or both.

At step 504, matching system 320 may receive a request to create and configure a new event using an event organizer interface. In particular embodiments, the event may include any information such as, for example, location, venue, venue map, themes, topics, etc. In particular embodiments, the event organizer interface may allow an event organizer to include a map of the venue and divide it into one or more “sections” that enable more efficient networking (e.g., “consumer focus,” “enterprise focus,” “software developers,” “marketing,” “legal,” etc.). In particular embodiments, event organizer interface may also receive distinguishing features of the venue to aid users in finding them or other attendees (e.g., bars, food tables, windows, decorations, statues, numberings, etc.).

At step 506, the event organizer interface may provide instructions and prompt for configuration information for the beacons 330. As an example, the event organizer interface may instruct the user to place beacons at particular locations in the venue. In an example, the interface may prompt the user to enter distances and orientations of the placed beacons. In particular embodiments, the interface may prompt the user to enter a calibration mode. As an example, the interface may prompt the user to walk in certain directions or distances to calibrate the beacon and location software (e.g., “Please walk from north to south,” “Please walk straight towards beacon 3,” etc.). Although particular ways of calibrating beacons and location software have been described, this disclosure contemplates any mechanisms for calibrating beacons and location software.

At step 508, matching system 320 receive confirmation of a user's arrival at the event through a check-in process. In particular embodiments, an attendee interface may detect that a user is located at or near the event venue and prompt the user to check-in (e.g., “It looks like you have arrived at ‘Startup Weekend Networking Event,’ would you like to check-in?”). In particular embodiments, the act of checking in may automatically trigger an action, such as instructing a batch printer to print a name-tag specific for a given user, display the attendee's name on a screen, etc. In particular embodiments, a matching server 320 may receive a camera input and perform an automatic check-in process using facial-recognition on the received camera feed.

At step 510, server 320 may generate a map of the checked-in attendees at the event with their detected location based on the beacon location system and may match users with other attendees. In particular embodiments, the attendee interface may display a map illustrating the location of the attendee and other attendees within the event venue. The map may further track the movement of the attendee and other attendees and update their location in real-time or quasi-real-time. In particular embodiments, the user interface may present a map that is based on the user's immediate proximity and area, and may present a radius around the user that shows the people around the user, information about them, and highlights a given number of the most relevant people on the basis of a preselected criteria or intent. In particular embodiments, the interface may present a picture of any user made conspicuous by any means within the app interface for purposes of real world identification.

In particular embodiments, client device 310 may comprise an AR/VR headset. One or more attendees may wear such a headset and be provided an augmented or virtual experience that adds an overlay to the user's interaction with the room. Client device 310 may show the user the room in real-time (or near real-time) with added text, images, sounds, animations, etc. that help the user navigate the room and network with the people around them. As an example, client device 310 may show the room with the names of other attendees superimposed over the heads of the attendees. As an example, client device 310 may add particular markers (e.g., a star, an arrow, a spotlight, etc.) to an attendee that system 320 has determined is a relevant person that matches the user's intent. As an example, client device 310 may include a path (e.g., a line, a set of arrows, directions, etc.) that guides user towards the relevant person. In particular embodiments, an augmented reality experience may be achieved using other devices, such as, for example, a smartphone with an integrated camera that shows the room on the smartphone's display and adds augmented reality elements. Although this disclosure describes augmented reality in a proximity based networking event matching system in particular manners, this disclosure contemplates augmented reality in a proximity based networking event matching system in any manner.

Server 320 may further send notifications to attendees about other attendees they may be interested in meeting. As an example, if the system detects that an attendee matches one of the intents of another attendee, the system may send one or both attendees a notification (e.g., “You may be interested in meeting Mark, a back-end software developer?”). The attendee interface may allow a user to confirm whether they want to meet the person, and then provide instructions and image to help locate the other attendee (e.g., “You may meet with Mark in front of the snack bar.”). In particular embodiments, the interface may allow an attendee to browse through a listing of other attendees and request to initiate a meeting. If the other attendee accepts then they may be furnished further instructions through the interface.

In particular embodiments, the interface may allow users to indicate within the interface whether they wish meet and/or did meet during the event. In particular embodiments, the interface aids users in adding other user contacts, and connecting on social networking platforms such as Facebook, LinkedIn, etc.

In particular embodiments, users are matched to one another on the basis of relative proximity and a single prioritized trait or characteristic, where the trait or characteristic is distinguishing between users or held in common. In particular embodiments, users are matched to one another on the basis of relative proximity and a number of traits or characteristics. In particular embodiments, any of a number or all of the aforementioned criteria for matching users are used in combination, whether simultaneously or at different times within the span of a single or multiple related social events.

In particular embodiments, data on interactions between people at different locations is gathered by the application and used for analytics and improvements to the matching systems or algorithms. In particular embodiments, server 320 may recognize that people connected during the event based circumstantial information, such as, for example, their locations during the event, the time spent at the locations, the sharing of information between the users (e.g., contacts added, friend requests, etc.), or any combination thereof. In particular embodiments, the data can be used for any useful analytics in any context. As an example, the information collected may permit the segmenting of the users into different populations. In particular embodiments, the data collected can be used to give companies detailed profiles of what types of people are successfully connecting, which can be used to suggest who might be appropriate to invite to another event. In an example, data analytics could be used to help people to determine where they should sit at events or open office environments based on the profiles of people connected to the app. In an example, the data collected by the app can be used to inform a consumer of other people nearby they may network with, such as in a social or consumer experience (e.g., a coffee shop, bar, park, etc.).

As will be appreciated by the foregoing, embodiments described herein utilize proximity and user data to perform a prioritized matching process. According to some embodiments, users determine the information shared and thus the data used in the matching process. Some user data is generated from user provided information. For example, user social media usage data (Facebook likes, Twitter tweets, etc.) can be used to generate a personality profile for the user categorized numerically in the Big Five personality traits. The user is able to provide biographical information such as that included in a social media (e.g. LinkedIn) profile. Additionally, embodiments can include a survey feature that lets the user express information for their matching profile such as intention for attending an event or place, preferences or taste information.

According to some embodiments, the user opt-in data gathering process prevents users from being caught off guard by which data they are using or sharing with others or system 300. With a matching profile of sufficient detail, the user is then quantitatively matched to users in the same proximity such that matches can be ranked by priority. The matching itself is completed using a variety of algorithms, depending on the context, where match profiles contain a set of numerical features that can then be compared. Presently, celebrity and friend personality matching is carried out by similarity calculations with more similar profiles scoring higher in user-to-user comparisons.

According to one embodiment, consider the following example of a similarity calculation which can be used to perform matching in accordance with the foregoing principles. Consider that each user has a match profile that consists of match categories such as personality, age, interests, favorite brands, etc. For the personality match category, as an example, the personality of the user is modeled after one of the established personality models and consists of a number of personality factors such as openness, conscientiousness, extraversion, agreeableness and emotional stability. The user's profile includes numerical estimates for each personality factor. When performing similarity analysis to determine the other users with the most similar personalities a similarity score can be calculated for each of the other users and used to sort all the compared users from most similar to least similar. The similarity score [0,1] is calculated as follows:

$${score}_{similarity} = 1 - \sqrt{\frac{{\sum }_{factors f} {( {user}_{f} - {other}_{f} )}^{2}}{{num}_{factors}}} \qquad ( 7 )$$

According to some embodiments, matching can be performed using a machine learning-based approach where optimal matches are learned from training data (hand-labeled match feature vector pairs created from experimentation with and observation of past user interactions) and improved over time with additional user data. The trained machine learning model is used to predict potential match scores in user-to-user comparisons.

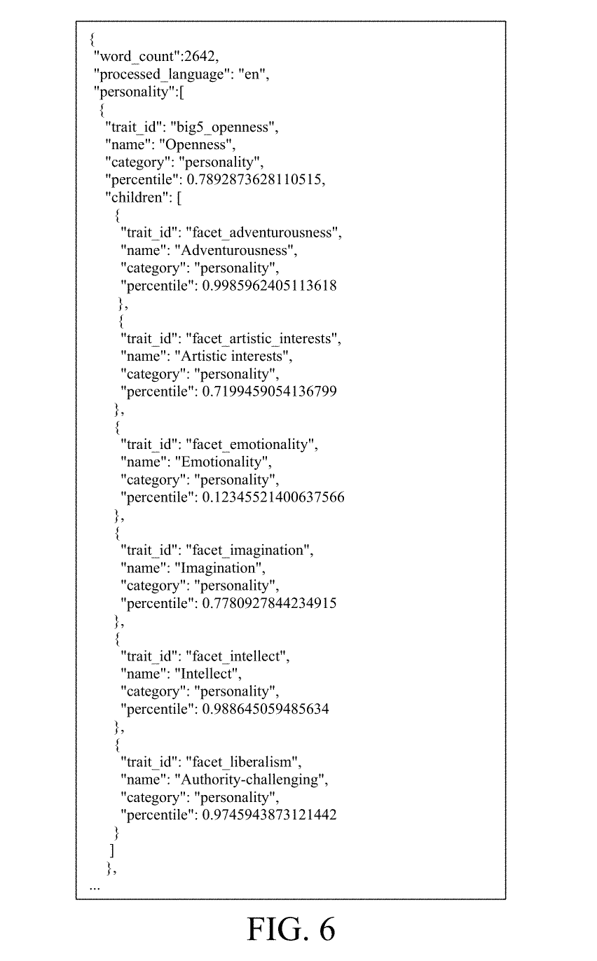

An example of acquiring matching data for a user from Twitter and using that matching data to create matches with other users to display, e.g., the matching information shown in FIGS. 4(a)-4(i) above will now be discussed. Consider that a user 404 grants permission in the proximity networking application running on his or her client device 310 to access their Twitter feed (i.e., which creates an authentication token to be used on their behalf to Twitter API). Using this authorization, the matching system 320 collects a set of user tweets (a large grouping of text) through a set of API calls to Twitter. The matching system 320 can then send this text data to a personality insight service, e.g., to the IBM Watson Personality Insights service, through an API call and receives back a personality profile JSON text response (a partial example of which is illustrated in FIG. 6).

Matching system 320 stores all, or certain portions, of the personality response in the user's matching profile as match features for that user. This is an example of derived match profile features where user information is provided and transformed into one or more match profile features. When personality matching is requested via a user's application, the user's match profile is compared against the pool of match candidates to determine the most similar personality matches, with similarity being defined as shortest Euclidean distance between feature vectors. With certain matching operations the feature vector is weighted with certain features being weighted stronger than others, with the weighting being manually injected or performed automatically using machine learning.

In the matching embodiment associated with equation (7), each of the personality features were treated equally when calculating the similarity score. However, this may not always be desired according to other embodiments. Often it is desired to weight a certain feature or set of features more strongly when performing match or similarity calculations. As an example, for the personality case possibly conscientiousness should be twice as powerful as the other features for personality comparison scoring. This weighting difference could be determined offline using feature engineering and analysis that supports fixed adjustments for a certain use case or could be learned in-system using various machine learning approaches. As an example, collaborative filtering techniques can be used to predict what other people, events or products the user may like based on the preferences of other users with similar opinions and match features. Clustering can also be used to determine the most similar match profiles for output via the user interface as described above. A self-organizing feature map is an unsupervised learning strategy that is used to group users that share unknown feature similarities across a large feature vector into a number of smaller bins based on patterns observed amongst users. By keeping flexibility in how users are grouped and matched, with utilizing a variety of approaches, the overall experience for the user in various geographical and proximal circumstances can be maximized.

End-user location data while in a zone being tracked by the proximity networking system 300 is tracked for analytics purposes and for tracking user-to-user interactions. Likely interactions are defined as periods of shared close proximity between two users for a certain amount of time. The system also allows users to connect in the user app, allowing for other forms of interaction.

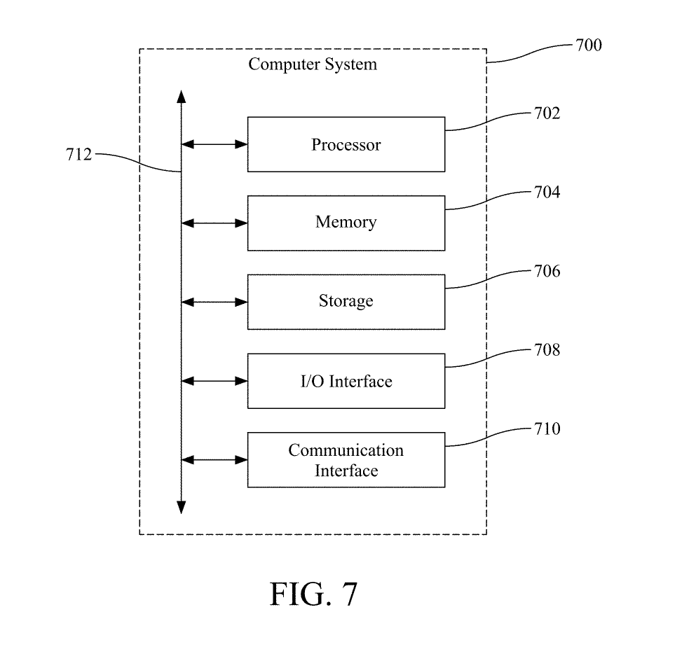

FIG. 7 illustrates an example computer system 700. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700. Herein, reference to a computer system may encompass a computing device, and vice versa, where appropriate. Moreover, reference to a computer system may encompass one or more computer systems, where appropriate. The computer system 700 can be used as a hardware architectural framework to implement a client device 310 or a matching system 320 described above.

This disclosure contemplates any suitable number of computer systems 700. This disclosure contemplates computer system 700 taking any suitable physical form. As example, computer system 700 may be an embedded computer system, a desktop computer system, a laptop or notebook computer system, a mainframe, a mobile telephone, a personal digital assistant (PDA), a server, or a tablet. Computer 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. This disclosure contemplates processor 702 including any suitable number of any suitable internal caches, where appropriate. In particular embodiments, processor 702 may include one or more internal registers for data, instructions, or addresses. This disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, memory 704 includes random access memory (RAM). This RAM may be volatile memory, where appropriate Memory 304 may include one or more memories 704, where appropriate. Although this disclosure describes and illustrates particular memory, this disclosure contemplates any suitable memory.

In particular embodiments, storage 706 includes mass storage for data or instructions. As an example, storage 706 may include a hard disk drive (HDD), a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both, providing one or more interfaces for communication between computer system 700 and one or more I/O devices. Computer system 700 may include one or more of these I/O devices, where appropriate. One or more of these I/O devices may enable communication between a person and computer system 700. As an example, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

### Wearable Augmented Reality IoT Powered Clothing

According to other embodiments, the afore-described systems and methods for proximity-based networking can be further enhanced with the addition of wearable augmented reality IoT powered clothing. As discussed previously the proximity-based networking systems and devices enable individuals, e.g., associated with an event or meeting, to be carefully mapped and color-coded based on their proximity to one another and their intentions and/or interests, as they move towards and away from other individuals or groups to enable new business and networking opportunities. According to the following embodiments, wearable enhanced t-shirts (or other clothing items), will integrate and communicate with such proximity-based networking systems to create an experience where people are able to more readily visualize other people's interests and intentions for, e.g., networking. The outcome of this will be to truly blend the digital and physical world by allowing people to more readily see an individual's interests and at a glance, understand a group's composition of interests. It will result in more effective, high quality interactions between individuals in social and business settings, enhancing a visitor's experience and likelihood to return.

Two wearable embodiments are presented below, although the present invention is not limited to those embodiments. According to a first embodiment, a wearable T-shirt presents information about the wearer that can be correlated by proximity-based networking system to obtain information that the wearer would like to share with others at the event. That information can then be presented to other people proximate the wearer, e.g., as displayed information via an application on their phone or other device. According to a second embodiment, the wearable T-shirt can also include its own hardware including a number of sensors that can be used to gauge the wearer's position and/or interest in engaging with other people at the event. Each of these embodiments will now be discussed in more detail in turn.

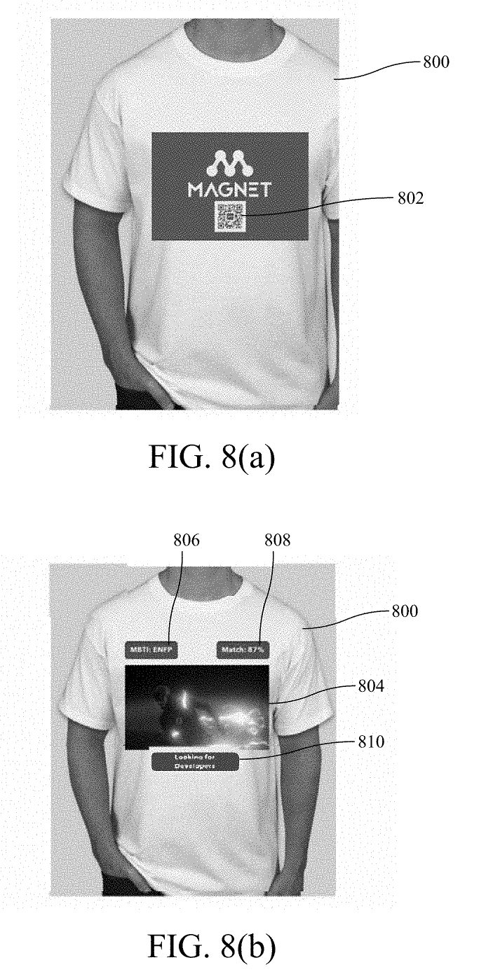

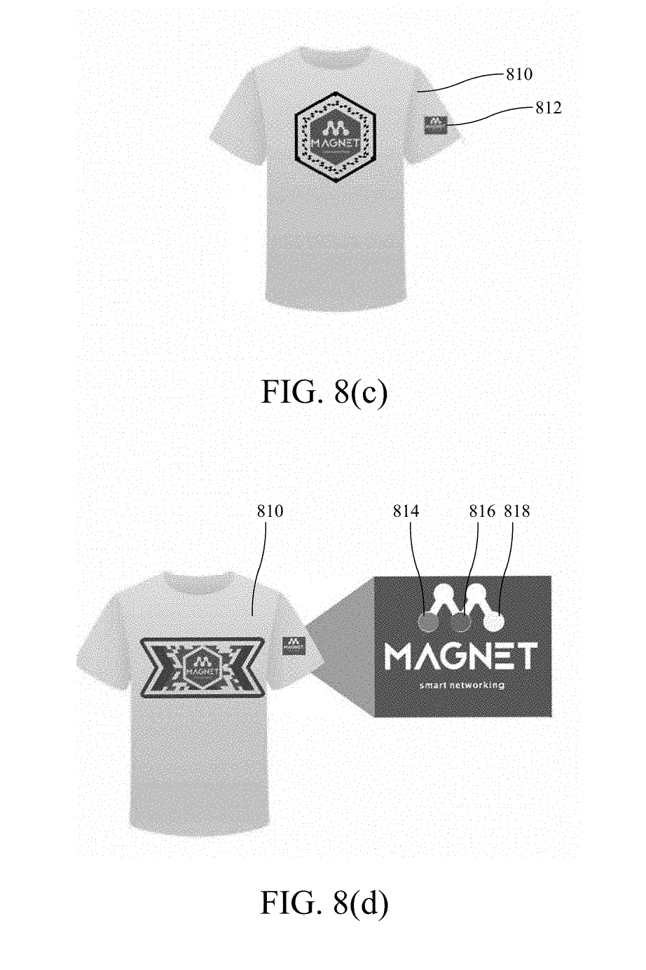

According to the first wearable embodiment, after people sign up for an event they receive a link to download a persona application. Using the persona application users can create a profile that estimates their personality and intent based on a variety of inputs (e.g. Facebook Like data, Twitter data, and survey data set by the organizer). The user can select an image from an image database as an interactive and visual way to broadcast their interests, mood or intent. Each user profile in the proximity-based networking system is paired with a purchased wearable, e.g., a t-shirt. As seen in FIG. 8(a), this t-shirt 800 is equipped with a QR code 802 that is connected to the persona app in the proximity-based networking system. Once the QR code 802 is scanned by the application of another user, the QR code information is returned to the matching system 330. The matching system 330 retrieves the user profile information which the user of the t-shirt 800 has provided for distribution and outputs that information to the user whose app scanned the QR code 802. The output of interest, intent and/or mood information associated with the wearer of the t-shirt 800 can, for example, take the form of an image or figure that the wearable user wants to display. According to one embodiment, and as shown in FIG. 8(b), this information appears on a rendition of the t-shirt that can be displayed on, e.g., the device of the user who scanned the QR code of the wearer of the t-shirt. As seen in the example of FIG. 8(b), the information can include the image 804 which was associated with the user profile and t-shirt 800, some personality information 806, some information 808 about how much of a match the two users are considered to be by the matching system 330 (e.g., based on the matchmaking techniques described in earlier embodiments), as well as some information 810 about the wearer of the t-shirt 800's intent/interest.

The persona app can also be used to help automatically sign people in to an event. As the person approaches the venue using GPS, Bluetooth, facial recognition and/or a QR code, the event organizer can see that they are already checked in and usher them on through or, conversely, can automatically check them in through the proximity-based networking system. Once inside when they are standing in a certain area, the proximity-based networking system knows who else is in that area and suggests people to talk to in their immediate vicinity (if the organizer wants that).

From the foregoing, it will be apparent that the first embodiment of a wearable that can interact with the proximity-based networking system includes information on the wearable worn by a first user which can be read by a second user's device (e.g., phone, glasses, another wearable device, etc.) to provide that second user with information about the first user that the first user has commissioned the proximity-based networking system to provide. According to a second embodiment, the wearable can provide additional functionality by adding one or more electronic devices to the wearable itself which can interact with the proximity-based networking system as will now be described.

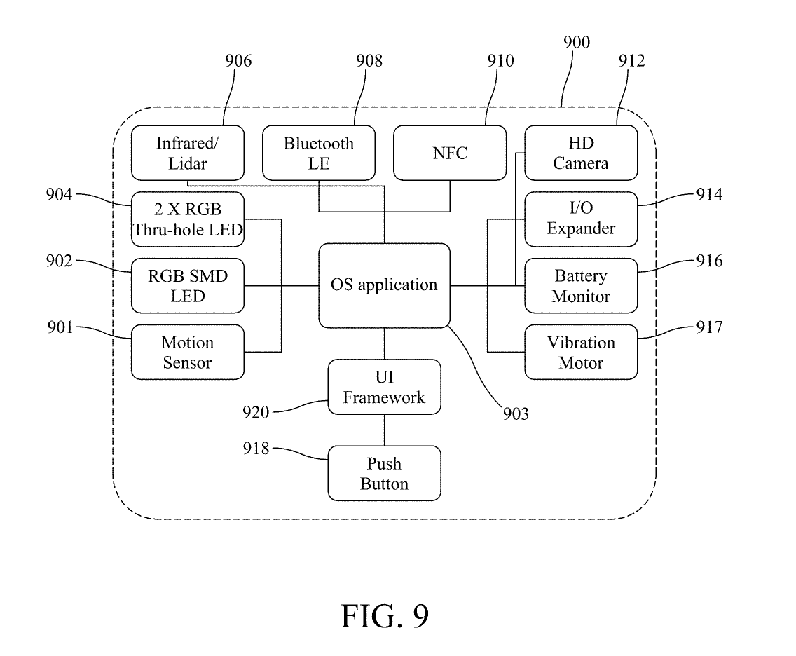

According to the second wearable embodiment, as shown in FIGS. 8(c) and 8(d), when the user activates the wearable electronic device in the t-shirt 810, located in, for example, a removable patch 812 on the right sleeve, an LED 814 embedded in the wearable is engaged to show that it is active. The wearable electronic device can have a plurality of LEDs as well as other associated electronics which are described below in more detail with respect to FIG. 9. In the example of FIG. 8(d), the wearable includes three LEDs 814, 816 and 818, but other embodiment may include more or fewer LEDs.

According to one embodiment, the color of LED 814 can be used to indicate the interests/intent of the person wearing the t-shirt 810, the color of LED 816 can be used to indicate the interests/intent of a group of people who are proximate the wearer of the t-shirt 810 and the color of LED 818 can be used to indicate the frequency of interaction of the person wearing the t-shirt 810 as described below.

According to an embodiment, the color of the LED 814 on startup is based on the user's persona which is generated by the persona application as described above. As a user approaches a venue with a proximity-based networking system as described in the various embodiments herein, the user will receive a notification that asks them to declare their interests or intent on the application on their user device. Upon doing so, the color of the LED 814 will change to reflect the user's intent/interests. For example, if the user's declared intent/interest is in ‘Strategy’, the LED 814 could be controlled to emit blue light (r,g,b. 0%, 0%, 100%).

As the wearer of t-shirt 810 approaches a proximity-based networked group that was, for example, composed of 40% Strategists, 30% Developers, and 30% Investors, the color of the LED 816 would, for example, show a color that indicated that a majority of the group were strategists, e.g., a blended color or blue 40%, red 30% and green 30%.

The third LED 818's can be used to indicate the interactivity of the wearer within the group. For example, the brightness of LED 818 can be controlled based upon how many people an individual has met. As described below, a connection or meeting between people who are profiled in the proximity-based networking system can be identified by the systems when two people shake hands or hug, which can be sensed by an inertial sensor disposed in the wearable electronic device, e.g., an accelerometer. The dimmer the brightness of LED 818, the fewer the number of people that they've met, the brighter the output of LED 818, the more people that they've met. This brightness can, according to one embodiment, be recalculated every so often, e.g., once per 15 minutes, in order to indicate recent interactivity of the individual.

According to another embodiment, in order to gamify the networking experience, when individuals connect with other people in the proximity-based networking system, they receive points and when they connect with an individual that hasn't met with a lot of other people they get more points encouraging extroverts to interact with introverts. As mentioned above, when a user connects with another user with a handshake (or a hug), which is detected using a 9-axis accelerometer in the device, this action is recorded in the application to measure an interaction. The user can also use the AR mode, i.e., the first wearable embodiment described above, to scan the front of the t-shirt 810 to see an AR gif along with persona data (e.g. Intent/Interest, MBTI, and Match %) on a customizable t-shirt design, which action would also count as an interaction for the purposes of awarding points for a gaming-like embodiment of the proximity-based networking system.

The foregoing provides one example of how interactions between people who are networking in proximity-based networking system including wearable devices can be implemented to provide information that helps people have a better networking experience by leading them to interact with those people who they are interested in meeting and encouraging them to have more interactions. However those skilled in the art will also appreciate that various permutations and alterations of the foregoing can lead to other embodiments of the present invention. For example, and according to another embodiment, indoor location data can be used to create some of these interactions using Lite OS/Open Connect, NB-IOT, and a BLE. In this scenario the second LED 816 could blend colors and show the make-up of an area of a room but also it could be displayed in AR.

Other variations are also contemplated. For example, the wearable electronic device could also be a wristband or badge instead of an insert into a t-shirt. Utilizing LiteOS could potentially enable the application to work with individuals who chose not to use an event app or the wearable t-Shirt. It could be used to broadcast color coded messages (i.e. a session is starting) to people throughout a venue. Future applications also include the use of an augmented reality portal application to set up a virtual show room when a person meets a business contact at an event. As augmented reality glasses reach the market, these experiences will become even more powerful. Instead of having the QR codes scanned by users' portable devices, IoT beacons placed in the desired environment/area can scan the QR codes and transmit the scanned data back to a central location for promulgation to the relevant client devices. Blockchain can be used to authenticate the wearables.

The foregoing describes some functionality associated with the integration of a wearable into the proximity-based networking device, be it an electronic wearable or a non-electronic wearable. With respect to the electronic wearable, an exemplary architecture of an electronic wearable 900 is illustrated in FIG. 9. Therein, motion sensor 901 can, for example, be an accelerometer which can, for example, output sensed motion data to the OS application 903 that can be used as inputs to a handshake or hug detection algorithm to determine whether an interaction has occurred as described above. LEDs 902 and 904 can be used to provide interactive outputs for the wearable as also described above. Optionally, wearable 900 could include infrared or lidar sensors to be used to provide additional information for location/positioning of the wearable 900.

The Bluetooth LE device 908 enables the wearable 900 to wirelessly communicate with the user's personal device, e.g., phone, on which the proximity-based networking system's client application runs. A near-field communication (NFC) device 910 can also be included to allow wearables which get into proximity with other wearables to recognize an interaction. An HD camera 912 can, optionally, be included to add further functionality related to positioning and/or networking interaction. An I/O expander 914 can be included to handle peripheral monitoring and control and to reduce the load on the main processor of the wearable 900 (which is represented in FIG. 9 by OS application block 903). A battery/battery monitor 916 can be provided to power the wearable 900, and a vibration motor 917 can be included to provide vibration output capability. Push button 918 operates to power on/off the wearable 900 and UI framework block represents the UI framework, e.g., that described in the embodiments above.

Those skilled in the art will recognize that embodiments of the electronic wearable need not include all of the elements illustrated in FIG. 9, but could instead only include subsets of those elements.

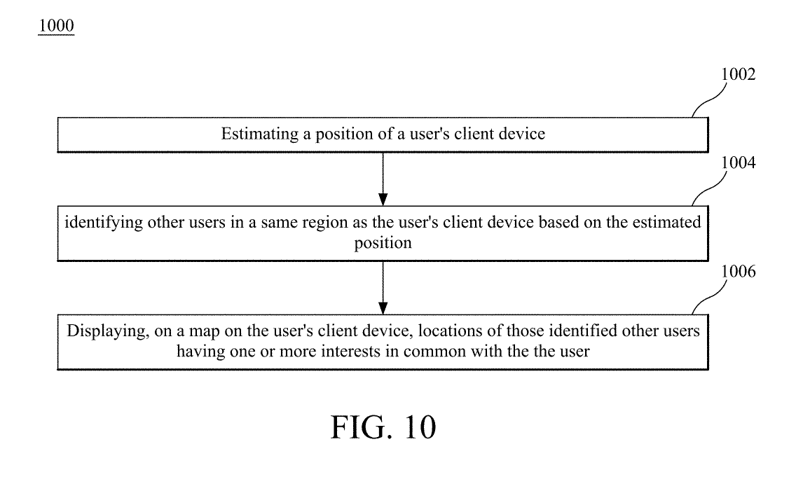

According to another embodiment, illustrated by the flowchart of FIG. 10, a method for proximity-based networking 1000 comprises estimating, at step 1002, a position of a user's client device; identifying, at step 1004, other users in a same region as the user's client device based on the estimated position; and displaying, at step 1006, on a map on the user's client device, locations of those identified other users having one or more interests in common with the user.

While the invention has been described herein with reference to exemplary embodiments for exemplary fields and applications, it should be understood that the invention is not limited thereto. Other embodiments and modifications thereto are possible, and are within the scope and spirit of the invention. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments may perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein.

Although the features and elements of the present embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general-purpose computer or a processor.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

1. A proximity-based networking system comprising:
a memory system for storing positioning data indicating estimated positions of a plurality of client devices within a building, wherein the positions are calculated as a function of:
Estimated Position=A(GPS based location estimate))+B(Bluetooth beacon-based location estimate)+C(geomagnetic-based location estimate)+D(vision-based location estimates)
where A, B, C and D are weighting values;
wherein said memory system also stores one or more interests associated with each of the plurality of client devices; and
one or more processors configured to identify two of the plurality of client devices as being a match when the two client devices are within a predetermined distance of one another based upon their stored positions and when the two client devices have at least one same or similar interest associated therewith.

2. A proximity-based networking system comprising:
a matching server configured to receive information associated with estimated positions of a plurality of client user devices and further configured to receive information associated with users' interests in attending a networking event; and
wherein a client user's device is configured to receive and to display information from the matching server associated with other users attending the networking event who have similar interests.

3. The system of claim 2, wherein the estimated positions of the plurality of client user client devices are inside of a building.

4. The system of claim 3, wherein the estimated positions of the plurality of client user devices are calculated as a function of a plurality of position updates, wherein each position update is calculated as:
A(GPS based location estimate)+B(Bluetooth beacon-based location estimate)+C(geomagnetic-based location estimate)+D(vision-based location estimate), where A, B, C and D are weighting values.

5. The system of claim 2, wherein a timestamp and an error estimate are associated with the estimated position.

6. The system of claim 5, wherein the timestamp and error estimate are used to filter the plurality of position updates used to calculate the estimated positions.

7. The system of claim 2, wherein the other users attending the networking event who have similar interests are identified by performing, at a matching server, a similarity analysis between a profile associated with the user and profiles associated with other users to identify the other users having one or more interests in common with the user; and transmitting information associated with the other users to the user's client device.

8. A method for proximity-based networking comprising:
estimating a position of a user's client device;
identifying other users in a same region as the user's client device based on the estimated position; and
displaying, on a map on the user's client device, locations of those identified other users having one or more interests in common with the user.

9. The method of claim 8, wherein the position of the user's client device is inside of a building.

10. The method of claim 8, wherein the step of estimating the position of the user's device further comprises:
calculating the estimated position as a function of a plurality of position updates, wherein each position update is calculated as:
A(GPS based location estimate))+B(Bluetooth beacon-based location estimate)+C(geomagnetic-based location estimate)+D(vision-based location estimate), where A, B, C and D are weighting values.

11. The method of claim 8, further comprising:
associating a timestamp and an error estimate with the estimated position.

12. The method of claim 11, wherein the timestamp and error estimate are used to filter plurality of position updates used to calculate the estimated position.

13. The method of claim 8, wherein the step of identifying other users having one or more interests in common with the user further comprises the step of:
performing, at a matching server, a similarity analysis between a profile associated with the user and profiles associated with other users to identify the other users having one or more interests in common with the user; and
transmitting information associated with the other users to the user's client device.

14. A proximity-based networking system comprising:
a plurality of wearables each associated with different users at a networking event; and
a matching server configured to receive information from a first user associated with one of the other users' associated wearable and further configured to receive information associated with users' interests in attending the networking event; and
wherein the matching server is configured to receive and to display information from associated with the one of the other users.

15. The proximity-based networking system of claim 14, wherein the plurality of wearables are items of clothing each having a Quick Response (QR) code affixed thereto which can be scanned by the first user's cell phone to generate the information which is transmitted to, and received by, the matching server.

16. The proximity-based networking system of claim 14, wherein the plurality of wearables are items of clothing having one or more light emitting diodes (LEDs) affixed thereto.

17. The proximity-based networking system of claim 16, wherein a color of light emitted by one of the one or more LEDs indicates an interest or an intent of a user wearing the item of clothing.

18. The proximity-based networking system of claim 16, wherein a color of light emitted by one of the one or more LEDs indicates an interest or an intent of a group of users proximate a user wearing the item of clothing.

19. The proximity-based networking system of claim 16, wherein a color of light emitted by one of the one or more LEDs indicates a frequency of interaction of a user wearing the item of clothing.
